(19) United States
(12) Patent Application Publication
(10) Pub. No.: US 2004/0243837 A1
(43) Pub. Date: Dec. 2, 2004

(54) Process and communication equipment for encrypting e-mail traffic between mail domains of the internet

(76) Inventors: Paul H. Fredette, Portsmouth, RI (US); Jason Murray, West Greenwich, RI (US); Paul R. Treciokas, Middletown, RI (US); Klaus Helbig, Berlin (DE); Karl-Heinz Weber, Berlin (DE); Hans-Jurgen Jacob, Berlin (DE)

Correspondence Address: ROBERT W. BECKER & ASSOCIATES, Suite B, 11896 N. Highway 14, Tijeras, NM, 87059, US

(21) Appl. No.: 10/260,022

(22) Filed: Feb. 21, 2001

(30) Foreign Application Priority Data
Feb. 21, 2000 (DE) 100 08 519.9

(51) Int. Cl. G06F 11/30; G06F 15/16

(52) U.S. Cl. 713/201; 709/206

(57) ABSTRACT

A process and communication equipment is provided for secured e-mail using security associations between mail domains of the Internet. E-mail passes though at least one device having a list of security associations. The sending domain equipment verifies the name of the destination domain of each e-mail received from its mail server based on a list of existing security associations. If there is no security association, the e-mail receives an identifier and is transferred to the receiver. If there is no identical communication equipment at the receiver, the e-mail is transferred in transparent state. If there is identical communication equipment at the receiver side, the e-mail is verified by the receiving equipment for an identifier and transferred to the receiver. If there is an entry in the security association list, the e-mail is transmitted in a secured state using the security parameters of the destination domain.

### BACKGROUND OF THE INVENTION

The present invention relates to a process and communication equipment for the establishment of secured e-mail traffic between domains of the Internet using security associations:

for keeping the content of e-mail secret,

for securing the integrity of the content of e-mail,

for protecting the identity of sender and receiver, when transmitting e-mail over insecure IP-networks.

It is a well-known fact that e-mail is one of the most insecure services of the Internet. E-mail contents are always transmitted as open text on their way over the Internet as IP-packets (for example on routers) or complete mails (for example on relay servers), and can easily be read or manipulated by unauthorized persons.

U.S. Pat. No. 4,962,532 and EP 375 138 B1 concern the exchange of electronic messages in networks. A process is described for controlling the delivery of electronic messages inclusive of the transmission of advice of non-delivery to sender and receiver. Together with the electronic message a message profile is transmitted that will be compared by the receiver with its system profile. The message will only be delivered if the system profile meets the requirements of the appropriate message profile. The message profile can also define that the transmission be encrypted.

The background of U.S. Pat. No. 5,787,177 is the remote access of users to local or global resources of a network. A process is described for controlling the right to access resources. To this end, security associations are established between objects in the network that define whether, when and in which way these objects can communicate with each other and third parties.

U.S. Pat. No. 5,493,692 describes the controlled delivery of electronic messages based on privacy, priority and text-related attributes. This information is stored in user profiles and analyzed by a user agent.

U.S. Pat. No. 4,672,572 includes the controlled communication between terminals and host computers via an additional protector device. This device contains identification means for, for example, access control, instruction filtering or encryption services.

DE 197 41 246 A1 describes the secure transmission of information between firewalls over an unsecured network based on IPSEC-standards. Proxy firewalls on the application level, however, are only able to operate if they receive the data in non-encrypted form. Therefore, the invention decodes data before they are delivered to the proxies on the IP-level, and carries out appropriate authentification processes.

Cryptography can make e-mail communication over the Internet more secure. At present, three different techniques are offered:

a) user-related e-mail security using encryption of mails on the mail client or on a mail server/mail proxy;

b) connection-related e-mail security using encryption of all IP-packets of an IP-tunnel (virtual private network);

c) domain-related e-mail security using encryption of mails on a mail gateway/mail proxy by using group certificates.

The techniques mentioned under a) submit the contents of single e-mails transmitted between end users to cryptographic processes. This user-related e-mail security provides all mail service features, but requires significant organizational efforts for the underlying public key encryption (Public Key Infrastructure—PKI) based on end-to-end security between users. The state-of-the-art is described, inter alia, in “S/MIME Version 3 Message Specification RFC 2633, June 1999” and “S/MIME Version 3 Certificate Handling RFC 2632, June 1999”.

The techniques mentioned under b) utilize cryptographic processes for securing the entire data transport between two mail servers or networks, respectively. When the connection-related techniques are used, no store-and-forward features of the mail service can be provided. The state-of-the-art is described, inter alia, in “Security Architecture for the Internet Protocol, RFC 2401, November 1998” and “The TLS Protocol Version 1.0, RFC 2246, Januar 1999”.

The techniques mentioned under b) serve to secure e-mails transmitted between security domains of the Internet based on domain encryption/decryption and domain signature. While maintaining all store-and-forward features of the mail service, these techniques referred to as “Domain Security Services” replace the certificates issued for each user with a group certificate for all users of a security domain. This reduces the effort for the realization of the public key encryption significantly. The state-of-the-art is described, inter alia, in “Domain Security Services using S/MIME, Internet draft, 1999”.

The three techniques mentioned under a), b) and c) have the significant additional effort in common that is required of the administrators, or users, respectively, for securing the e-mails, making the use of the e-mail service more expensive. For example, additional network, or software, respectively, components have to be installed in the IT-network, and the open or secured transmission of an e-mail has to be decided. Therefore, these techniques do not scale easily and are incompatible with the demand for open architecture of the Internet.

Therefore, the objective of the invention is to create a process and equipment for the establishment of secured e-mail traffic between mail domains of the Internet, which function transparent to all other net components (network transparency), transparent to the sender/receiver of mail (user transparency) and without any manual intervention (freedom from operation).

### SUMMARY OF THE INVENTION

According to the present invention, this problem is solved by a process for the establishment of secured e-mail traffic between domains of the Internet using security associations, in which the e-mails pass at least one piece of communication equipment, which is provided with a list of security associations and the communication equipment of the sending domain checks the name of the destination domain of each e-mail received for delivery from the mail server of its own domain against a list of existing security associations (SAs).

If there is no entry in the SA list,

the e-mail is provided with an identifier of the communication equipment and transferred to the receiver,

at the receiver side, if there is no communication equipment of identical type, the e-mail is transferred to the receiver in transparent state,

at the receiver side, if there is a communication equipment of identical type, the received e-mail is checked by the receiving communication equipment for an identifier and transferred to the receiver.

A received identifier causes the transmission of the security parameters of its domain to the communication equipment of the sender domain by secured e-mail.

Security parameters received in this way cause its security parameters of the domain to be transmitted to the communication equipment of the other domain by secured e-mail, if they have not already been transmitted, and security parameters to be entered in a list of security associations (abbreviated “SA-list”).

If there is an entry in the SA list, the e-mail is transmitted in secured state by the communication equipment based on the security parameters of the security association to the destination domain. The communication equipment of the destination domain converts the e-mail to its original unsecured state based on the security parameters of the security association and transfers it to the mail server appropriate to the domain.

In an advantageous embodiment of the invention, the process according to the invention is performed in such a way that if there is no entry in the SA list, the communication equipment

requests by e-mail that a security association be established and,

if a security association is achieved, transmits the e-mail in secured state or,

if a security association is not achieved, returns the e-mail to the sender as not deliverable in the secured state.

If there is an entry in the SA list, the communication equipment inquires by e-mail as to the present availability of a security association. If a security association is available, the e-mail is transmitted in secured state. If no security association is available, the e-mail is returned to the sender as not deliverable in the secured state.

The process according to the invention is a self-learning process for the user-transparent securing of e-mail traffic between mail domains of the Internet. The self-learning algorithm refers to the learning of communication equipment in the Internet and the automatic exchange of security parameters for the establishment of security associations through e-mail. The process according to the invention is characterized by the fact that the only mail domains that are learned are those between which mail traffic occurs. After transmission of the first open mail to a domain that is also secured by such communication equipment, a security association (SA) starts to be established between both communication devices. As soon as the security association has been established, all further mail between both communication devices is transmitted in a secured state, without any user activity.

In one advantageous embodiment of the present invention, if a security association is available, the data communication between the user and the communication equipment is direct and over a secured connection, for example, using the HTTPS-protocol. For that to occur, the user inputs the message and one or several receiver addresses over a secure interface into the communication equipment. The communication equipment creates an identifier and transmits it together with the receiver addresses to the mail server. The mail server arranges for the mail to be transmitted over the communication equipment, which adds the secured message based on the identifier. At the receiver side, the received mail equipped with an identifier is identified. The secured message is taken from the mail and stored in the communication equipment. The identifier is handed over to the receiver. Using this identifier the receiver can then pick up the secured message in direct way to the communication equipment.

In FIG. 1 the operation of the process is illustrated in process steps:

1) Without communication equipment, all e-mails between the domains A and B run open over the Internet.

2) Domain A is provided with communication equipment (KE). All e-mails that are sent are given an identifier by the communication equipment. This identifier is transparent to the users in the domains.

3) Domain B is also provided with communication equipment. When this communication equipment receives an e-mail from domain A with an identifier, it sends its security parameters through secured e-mail to the communication equipment in domain A, which then establishes a security association with domain B. The communication equipment in domain A, in its turn, sends its security parameters to the communication equipment in domain B, which then establishes a security association with domain A.

4) After the establishment of the security associations, each e-mail between the domains A and B, or B and A, respectively, is transmitted in a secured state and transformed to open mail based on the security parameters.

The process for the exchange of security parameters is activated whenever

the first open e-mail is exchanged between existing communication equipment and newly installed communication equipment, or

the first open e-mail is exchanged between newly installed communication equipment and existing communication equipment.

In this way, each communication device or equipment learns a list of security parameters of all communication devices, with which data traffic occurs (SA-database). Only an entry in this SA-database is required to decide whether an open or a secured e-mail is transmitted between two domains.

In an advantageous embodiment of the invention, the process is modified such that a user gains control over the secure transmission of e-mail by means of an additional mark in the e-mail.

In no case is an e-mail transmitted open.

If there are no security parameters for the receiver domain given in the SA-database, the communication equipment attempts to request them.

If there are no security parameters available, and they cannot be gained, the e-mail is returned to the sender as not deliverable in the secured state.

The process according to the invention can be realized using different communication equipment. The communication equipment realizing the process can be classified into four classes:

Class A: network-transparent encryption unit in the mail mode

Class B: network-transparent encryption unit in the packet mode

Class C: additional component for IP-device with mail server

Class D: additional component for IP-device without mail server

Communication Equipment Class A

Class A communication equipment for the establishment of secured e-mail traffic between domains of the Internet using security associations essentially consists of interface modules, a processor, a main memory and program memory, a crypto-module, a power supply, and the appropriate electrical connections and a bus for address and data exchange. It is characterized in that

it has two interfaces, over which it is integrated into the network in the interface (1) between network and mail server, or in the interface (2) between network and router,

it adapts to the existing network by auto-configuration and self-learning of network parameters without changes of network components,

it can select e-mail from the data flow using filtering mechanisms,

it is provided with a list of security associations,

it can exchange secured e-mail with any type-identical communication equipment of classes A, B, C or D by auto-configuration and self-learning of security parameters according to the process of the invention.

The communication equipment in Class A is inserted into a local network between the mail server and the network, or between the Internet access point and the network. No changes of the network components (router, gateways) or mail system (mail server, mail clients) have to be made (network transparency). The communication equipment configures itself as required for communication in the network. Parameters required for communication (IP-addresses, names, routes) are read from the data flow during a learning phase. After this learning phase a multi-phase filtering mechanism ensures that e-mail to be secured or secured, respectively, can be selected from the data flow:

passing of non-IP-traffic,

transfer of not mail-relevant traffic,

transfer of not security-relevant mail traffic.

Selected e-mails are then treated according to the process of the present invention.

Communication Equipment Class B

Class B communication equipment is in its design similar to Class A and is characterized in that

it has two interfaces, over which it is integrated into the network in the interface (1) between network and mail server, or in the interface (2) between network and router,

it adapts to the existing network by auto-configuration and self-learning of network parameters without changes of network components,

it can select data packets of e-mail from the data flow using filtering mechanisms,

it is provided with a list of security associations,

it can exchange secured e-mail with any type-identical communication equipment of classes A, B, C or D by auto-configuration and self-learning of security parameters according to the process of the invention.

The communication equipment in Class B is inserted into a local network between the mail server and the network, or between the Internet access point and the network. No changes of the network components (router, gateways) or mail system (mail server, mail clients) have to be made (network transparency). The communication equipment configures itself as required for communication in the network. Parameters required for communication (IP-addresses, names, routes) are read from the data flow during a learning phase. After this learning phase a multi-phase filtering mechanism ensures that data packets to be secured or secured, respectively, can be selected from the data flow:

passing of non-IP-traffic,

transfer of not mail-relevant traffic,

transfer of not security-relevant mail traffic.

The selected data packets are then treated according to the process of the present invention.

Communication Equipment Class C

Class C communication equipment for the establishment of secured e-mail traffic between domains of the Internet using security associations consists of a mail server, or Internet server with integrated mail server, respectively, and crypto-module. It is characterized in that

it can exchange e-mail with the mail server via an internal mail interface,

it is provided with a list of security associations,

it can exchange secured e-mail with any type-identical communication equipment of classes A, B, C or D by auto-configuration and self-learning of security parameters according to the process of the present invention.

Communication Equipment Class D

Class D communication equipment is any IP-capable device (for example, router, firewall) and is provided with a list of security associations. A multi-phase filtering mechanism ensures that e-mail-relevant data packets are selected from the data flow. The selected e-mail data are then treated according to the process of the invention.

The communication equipment Class C and D are devices with typical PC architecture extended by crypto-modules.

### BRIEF DESCRIPTION OF THE DRAWINGS

In the following, the present invention is explained in greater detail in an example of an embodiment for communication equipment (KE) Class A (called “box” in the following) by means of the drawings given. It is shown by

FIG. 1 the already described process steps,

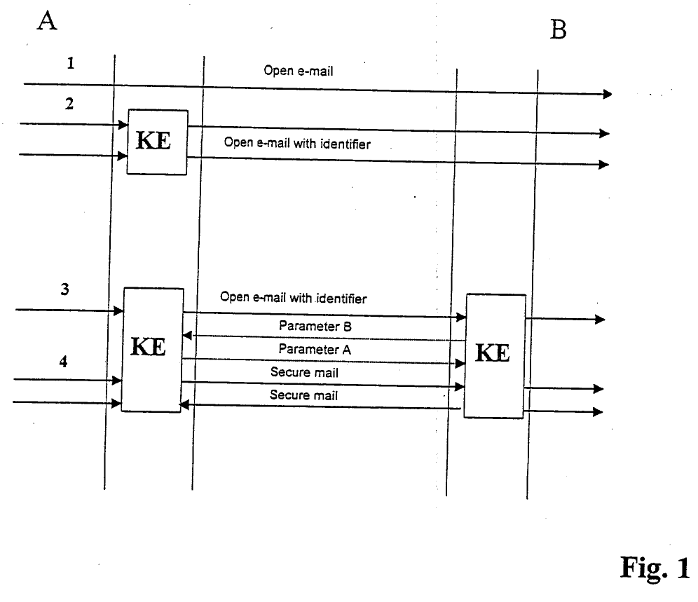

FIG. 2 the position of the box in the network,

FIG. 3 the structure of a box,

FIG. 4 the block diagram of a box,

FIG. 5 the representation of the course of the process beween 2 boxes—starting condition,

FIG. 6 the representation of the course of the process between 2 boxes—box in domain A,

FIG. 7 the representation of the course of the process between 2 boxes—establishment of security associations, and

FIG. 8 the representation of the course of the process between 2 boxes—secure e-mail transmission.

### DESCRIPTION OF PREFERRED EMBODIMENTS

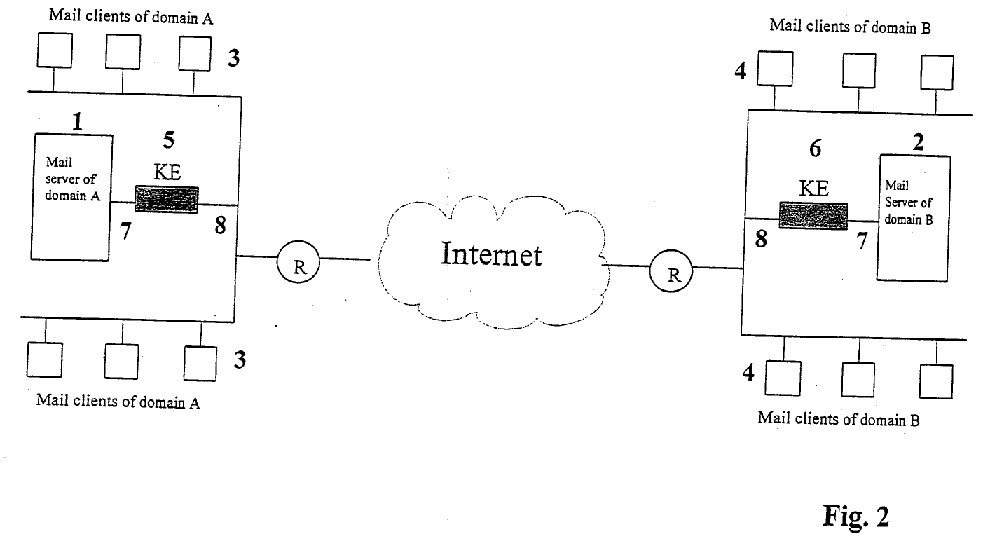

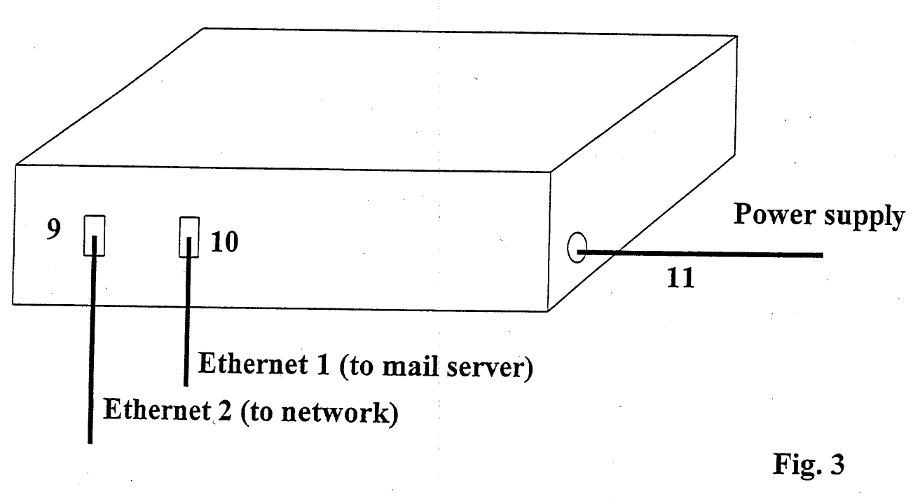

FIG. 2 shows the position of the box (5, 6) in a local network with a mail server (1, 2) for each domain and appropriate mail clients (3, 4). The box has a connection (7) in the direction of the mail server and a connection (8) in the direction of the network. The appropriate connection ports (9, 10) of a box are shown in FIG. 3. The box has only one other connection port (11) for a power supply.

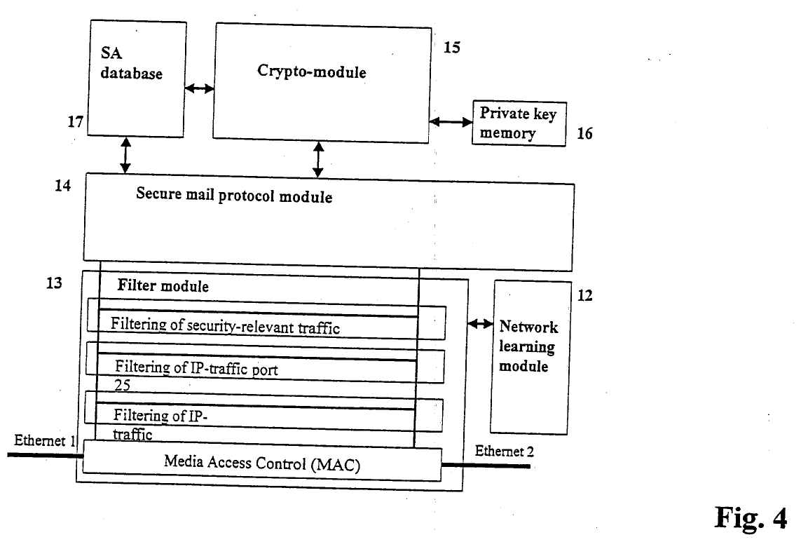

FIG. 4 shows the block diagram of a box of Class A. A network learning module (12) ensures that, after insertion into the Ethernet branch between mail server (Ethernet 1) and network (Ethernet 2), the box automatically learns all necessary network parameters, such as network address, IP-address of the mail server, domain name. Based on this, the filter module (13) can select all e-mails that are relevant in view of secure transmission. These e-mails are transferred to the secure mail protocol module (14). This module realizes the process supported by the SA database (17) and crypto-module (15). The crypto-module makes use of the private key store (16) to provide its private keys, and the SA database (17) to provide the public keys of the partners.

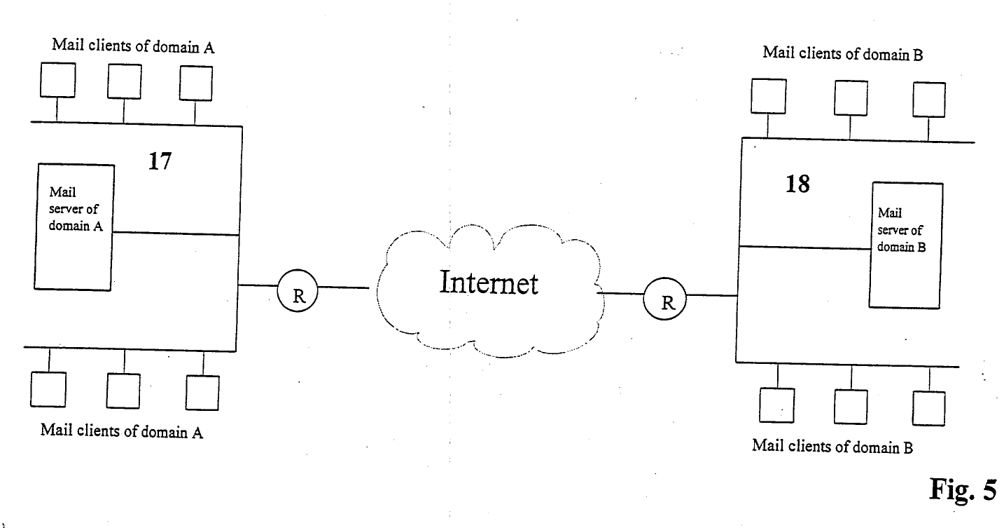

The flowchart of the process is shown in FIGS. 5-8. It is the e-mail traffic between all mail clients of the mail domain A (17) and mail domain B (18) that is to be secured. The starting situation is shown in FIG. 5.

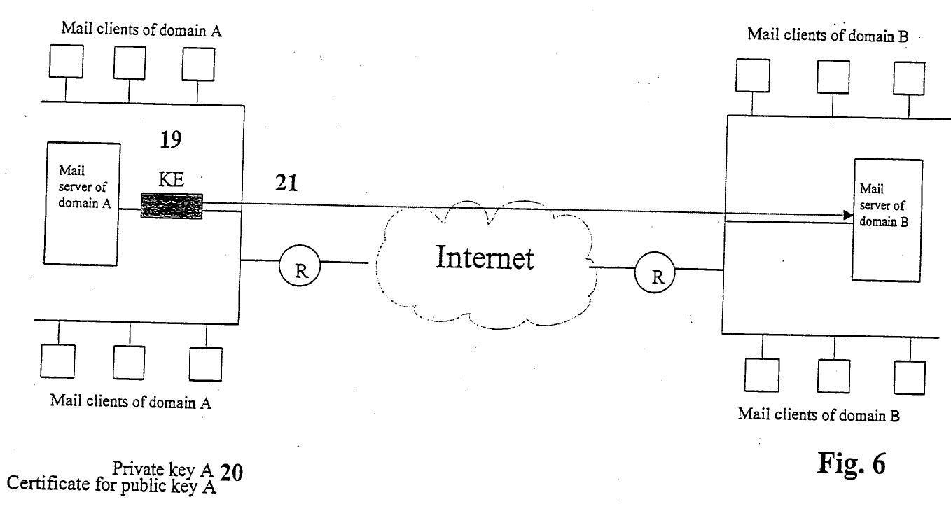

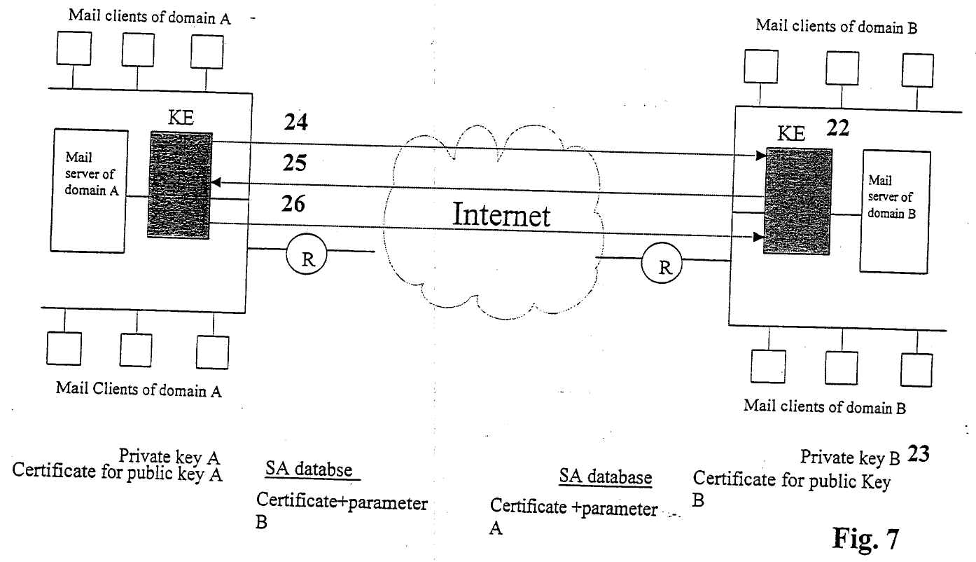

After, as shown in FIG. 6, a box (19) has been inserted in the range of mail domain A between the mail server responsible for domain A and the network, the box learns the concrete network environment and generates a crypto-pair (20). At that point in time, the SA database has not yet obtained an entry. Each e-mail to a client of the domain B or any other client outside of the domain is selected from the data flow by the box and before further transmission, is given a specific identifier in its header. An e-mail to a client of the domain B (21) is transferred to the mail client with the identifier being transparent for it. The same procedure applies for the installation of a box in the range of the domain B (22, 23) to FIG. 7. The process is based on the assumption that both boxes have their public keys certified by a trustworthy third party. This can occur, for example, in the box itself, on the basis of secured e-mail sent to a certificate server or by an external certificate (for example, Smartcard, SmartCD). For the process itself, the method of receiving certification is irrelevant.

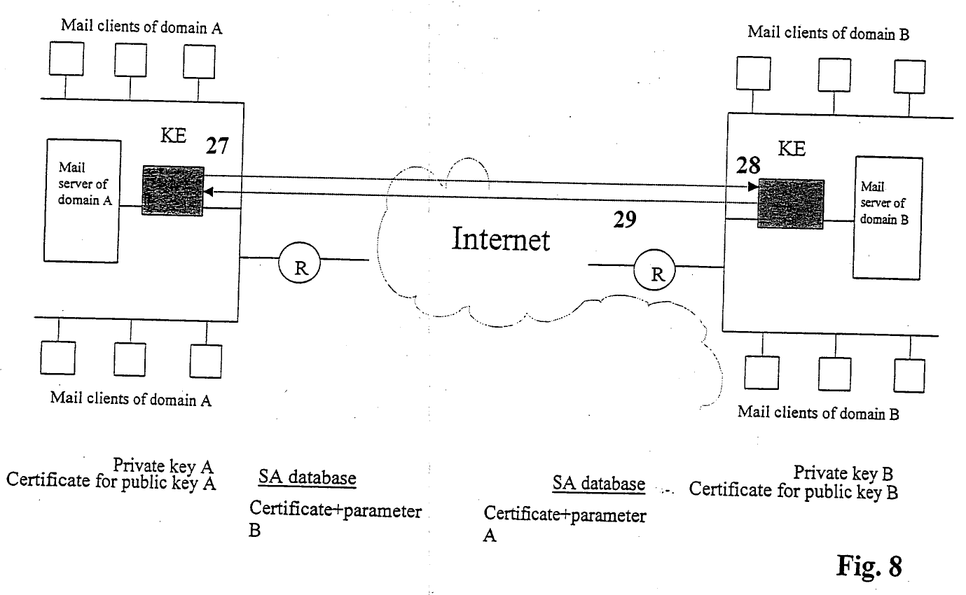

When an e-mail provided with an identifier from the domain A (24) is received by the box in the domain B, this box recognizes the identifier and the process of establishing security associations (SAs) and exchanging of certificates starts. For that to occur, the box of the domain B sends its certificate and security parameters by secured e-mail to the box A (25). The box A (25) makes its first entry in the SA database and sends its certificate and security parameters by secured e-mail to the box B (26). As a result, security associations exist between A and B in both directions (see FIG. 8). When a mail client of domain A sends an e-mail to a mail client of domain B (27), this e-mail is selected from the data flow by box A and the availability of a security association for domain B is recognized. The original mail is encrypted using the public key of domain B, signed using the private key of domain A and, provided with a new header using virtual user names, sent to box B. Box B selects the secured e-mail from the data flow (28), decrypts the e-mail using its private key and checks the content of the e-mail through the digital signature. The recovered open e-mail is transferred to the mail server of domain B. A similar procedure applies to sending of e-mail between the domains B and A (29). In this way, each box learns the existence of all other boxes that are already working in other domains or boxes that will be installed at a later time.

The specification incorporates by reference the disclosure of German priority document 100 08 519.9 of Feb. 21, 2000.

The present invention is, of course, in no way restricted to the specific disclosure of the specification and drawings, but also encompasses any modifications within the scope of the appended claims.

1. A process for the establishment of secured e-mail traffic between domains of the Internet using security associations, said process including the steps of:
passing the data through at least one communication equipment that is provided with a list of security associations,
having the communication equipment of the sending domain check the name of the destination domain of each e-mail received from the mail server of its own domain against a list of existing security associations,
in case of no entry of a security association in the list of security associations, providing the e-mail with an identifier of the communication equipment and transferring the e-mail to the receiver,
at the receiver side, if there is no type-identical communication equipment, transferring the e-mail to the receiver in unchanged state,
at the receiver side, if there is type-identical communication equipment, checking the received e-mail by the receiving communication equipment for an identifier and transferring the e-mail to the receiver in unchanged state,
wherein received identifiers cause the transmission of the domain's own security parameters to the communication equipment of the other domain in each case by secured e-mail, if they have not already been transmitted,
wherein received security parameters cause the domain's own security parameters to be transmitted to the communication equipment of the other domain by secured e-mail, if they have not yet been transmitted,
wherein the reception of security parameters causes the entry of them in the list of security associations,
in case of an entry of a security association in the list of security associations, the e-mail is transmitted in the secured state based on the security parameters of the security association by the communication equipment to the destination domain, and
the communication equipment of the destination domain converts the e-mail to its original unsecured state based on the security parameters of the security association and transfers it to the mail server appropriate to the domain.

2. The process of claim 1, wherein
in case of no entry in the list, the communication equipment requests through e-mail that a security association be established,
if a security association is achieved, transmits the e-mail in secured state, and
if a security association is not achieved, returns the e-mail to the sender marked as not deliverable in the secured state.

3. The process of claim 1, wherein
in case of an entry in the list, the communication equipment inquires by e-mail about the availability of a security association for the time being,
in case of availability of a security association, transmits the e-mail in the secured state, and
if no security association is available, returns the e-mail to the sender marked as not deliverable in the secured state.

4. The process of claim 1, wherein the user obtains a message about the operation of the process by means of an additional tag in the e-mail.

5. The process of claim 1, wherein if a security association is available, the data communication between user and communication equipment occurs in a direct way and over a secured connection.

6. Communication equipment for the establishment of secured e-mail traffic between domains of the Internet using security associations, comprising interface modules, a processor, a main memory and program memory, a crypto-module, a power supply, and appropriate electrical connections and a bus for the address and data exchange, further comprising:
two interfaces, over which it is integrated into the network in the interface (1) between network and mail server, or in the interface (2) between network and router,
wherein it is suited to take parameters required for the communication from the data flow (IP-addresses, names, routes),
wherein it adapts to the existing network by auto-configuration and self-learning of network parameters without changes of network components,
wherein it can select e-mails or data packets of e-mail from the data flow using filtering mechanisms,
wherein it is provided with a list of security associations, and
wherein it can exchange secured e-mail with type-identical communication equipment by auto-configuration and self-learning of security parameters according to the process of claim 1.

7. Communication equipment for the establishment of secured e-mail traffic between domains of the Internet using security associations, comprising of a mail server or Internet server, respectively, with integrated mail server and crypto-module, wherein
it can exchange e-mails with the mail server via an internal mail interface,
it is provided with a list of security associations, and
it can exchange secured e-mails with type-identical communication equipment by auto-configuration and self-learning of security parameters according to the process of claim 1.

8. Communication equipment for the establishment of secured e-mail traffic between domains of the Internet using security associations, comprising an IP-capable device, wherein
it can select e-mail-relevant data packets from the data flow using filtering mechanisms,
it is provided with a list of security associations, and
it can exchange secured e-mails with any type-identical communication equipment by auto-configuration and self-learning of security parameters according to the process of claim 1.
